(19) United States
(12) Patent Application Publication
(10) Pub. No.: US 2016/0021585 A1
(43) Pub. Date: Jan. 21, 2016

(54) Avoiding Secondary Cell Configuration for High Speed User Equipment

(71) Applicant: NOKIA SOLUTIONS AND NETWORKS OY, Espoo (FI)

(72) Inventors: Klaus Ingemann PEDERSEN, Aalborg (DK); Mikko SAILY, Laukkoski (FI); Per Henrik MICHAELSEN, Aalborg (DK); Simone BARBERA, Aalborg (DK)

(21) Appl. No.: 14/781,956

(22) PCT Filed: Apr. 4, 2013
(86) PCT No.: PCT/EP2013/057065

§ 371 Date: Oct. 2, 2015

(51) Int. Cl. H04W 36/00

(52) U.S. Cl. CPC H04W 36/0083; H04W 36/32

(57) ABSTRACT

Avoiding secondary cell configuration for high speed user equipment The present invention provides methods, apparatuses and computer program product relating to avoiding Scell configuration for high speed user equipment. The present invention includes determining, at a user equipment located in a coverage area of a first base station and a second base station, a mobility state of the user equipment, if it is determined that the user equipment is in a high mobility state, enabling configuring only a primary serving cell at the first base station.

### FIELD OF THE INVENTION

The present invention relates to avoiding secondary cell (Scell) configuration for high speed user equipment. In particular, the present invention relates to apparatuses, methods and a program for avoiding Scell configuration for high speed user equipment.

### BACKGROUND OF THE INVENTION

The present invention relates to a case with inter-site carrier aggregation (CA) between macro cells and small cells deployed at different carriers. In particular, an LTE scenario with macro cells at carrier frequency f1 and small cells at carrier frequency f2 is assumed, where f1<f2 to provide better coverage for the macro layer. The small cells are mainly deployed for providing hotspot coverage at locations where the user density is typically higher. Only the macro layer is assumed to offer wide area coverage. User equipments (UEs) with CA can be configured to receive data from carriers at the macro and small cell layer simultaneously. For the sake of simplicity of the following description, it is assumed that the primary cell (PCell) is always at the macro layer, while the secondary cell (SCell) is on the small cell layer. However, the present invention is not limited thereto.

Intra-frequency PCell handover at the macro-layer is assumed to be based on reference signal receiving power (RSRP) event A3, while SCell addition and removal are based on reference signal receiving quality (RSRQ) event A4 and A2, respectively. Intra-frequency SCell change on the pico-layer is triggered by RSRP event A6 (signal level from another SCell candidate becomes a threshold better than current SCell). An example of the various mobility events that may happen to a UE with CA, when following a certain trajectory, is illustrated in FIG. 1. For all the considered UE radio resource management (RRM) events, the UE performs Layer-1 and Layer-3 filtering of the RSRP and RSRQ measurements, as well as includes the time-to-trigger (TTT) criteria according to the 3GPP TS 36.331.

Whenever a handover, or SCell addition/release, takes place, it also involves sending a radio resource control (RRC) reconfiguration command (a.k.a. handover command) to the UE as well as inter-node signaling between the involved network elements.

In view of the scenario illustrated in FIG. 1, there is a problem that there would be a large number of handover or SCell addition/remove procedures if a UE moves with a high speed along the trajectory illustrate din FIG. 1. This would cause a large signalling overhead between the involved network elements.

### SUMMARY OF THE INVENTION

It is therefore an object of the present invention to overcome the above mentioned problems and to provide methods, apparatuses and a program for avoiding Scell configuration on for high speed user equipment.

According to an aspect of the present invention there is provided a method comprising:
determining, at a user equipment located in a coverage area of a first base station and a second base station, a mobility state of the user equipment,
if it is determined that the user equipment is in a high mobility state,
enabling configuring only a primary serving cell at the first base station.

According to further refinements of the present invention as defined under the above aspect

the method further comprises restricting configuring a secondary cell at the second base station;

restricting configuring a secondary cell at the second base station includes restricting transmission of radio resource management mobility events related to addition of a secondary cell to the network;

restricting configuring a secondary cell at the second base station includes restricting transmission of a request for addition of a secondary cell on a random access channel;

the mobility state of the user equipment refers to a moving speed of the user equipment and the user equipment is in a high mobility state when the moving speed of the user equipment is higher than a predetermined threshold;

the method further comprises, if it is determined that the user equipment is not in a high mobility state, enabling configuring a primary serving cell at the first base station and configuring a secondary cell at the second base station.

the first base station is a macro base station and the second base station is a small cell base station.

According to an aspect of the present invention there is provided a method comprising:
estimating, at a network element, a mobility state of a user equipment located in a coverage area of a first base station and a second base station,
if it is determined that the user equipment is in a high mobility state,
configuring only a primary serving cell at the first base station.

According to further refinements of the present invention as defined under the above aspect, the method further comprises restricting configuring a secondary cell at the second base station;

the mobility state of the user equipment is estimated based on a rate of cell changes obtained based on a time the user equipment has been located in previous cells and the type of the cells;

the user equipment is in a high mobility state if the rate of cell changes is higher than a threshold;

the method further comprises, if it is determined that the user equipment is not in a high mobility state, enabling configuring a primary serving cell at the first base station and configuring a secondary cell at the second base station;

the first base station is a macro base station and the second base station is a small cell base station.

According to an aspect of the present invention there is provided an apparatus for use in a user equipment, comprising:
at least one processor,
at least one interface to at least one other network element, and
at least one memory for storing instructions to be executed by the processor, wherein
the at least one memory and the instructions are configured to, with the at least one processor, cause the apparatus at least to perform:
determining, at the user equipment located in a coverage area of a first base station and a second base station, a mobility state of the user equipment,
if it is determined that the user equipment is in a high mobility state,
enabling configuring only a primary serving cell at the first base station.

According to further refinements of the present invention as defined under the above aspect,

the at least one memory and the instructions are further configured to, with the at least one processor, cause the apparatus to perform restricting configuring a secondary cell at the second base station;

restricting configuring a secondary cell at the second base station

includes restricting transmission of radio resource management mobility events related to addition of a secondary cell to the network;

restricting configuring a secondary cell at the second base station

includes restricting transmission of a request for addition of a secondary cell on a random access channel;

the mobility state of the user equipment refers to a moving speed of the user equipment and the user equipment is in a high mobility state when the moving speed of the user equipment is higher than a predetermined threshold;

the at least one memory and the instructions are further configured to, with the at least one processor, cause the apparatus to perform, if it is determined that the user equipment is not in a high mobility state, enabling configuring a primary serving cell at the first base station and configuring a secondary cell at the second base station

the first base station is a macro base station and the second base station is a small cell base station;

According to an aspect of the present invention there is provided an apparatus, comprising:
at least one processor,
at least one interface to at least one other network element, and
at least one memory for storing instructions to be executed by the processor, wherein
the at least one memory and the instructions are configured to, with the at least one processor, cause the apparatus at least to perform:
estimating a mobility state of a user equipment located in a coverage area of a first base station and a second base station,
if it is determined that the user equipment is in a high mobility state,
configuring only a primary serving cell at the first base station.

According to further refinements of the present invention as defined under the above aspect,

the at least one memory and the instructions are further configured to, with the at least one processor, cause the apparatus to perform restricting configuring a secondary cell at the second base station;

the mobility state of the user equipment is estimated based on a rate of cell changes obtained based on a time the user equipment has been located in previous cells and the type of the cells;

the user equipment is in a high mobility state if the rate of cell changes is higher than a threshold;

the at least one memory and the instructions are further configured to, with the at least one processor, cause the apparatus to perform, if it is determined that the user equipment is not in a high mobility state, enabling configuring a primary serving cell at the first base station and configuring a secondary cell at the second base station;

the first base station is a macro base station and the second base station is a small cell base station;

According to an aspect of the present invention there is provided an apparatus for use in a user equipment, comprising
means for determining, at a user equipment located in a coverage area of a first base station and a second base station, a mobility state of the user equipment,
if it is determined that the user equipment is in a high mobility state,
means for enabling configuring only a primary serving cell at the first base station.

According to an aspect of the present invention there is provided an apparatus, comprising:
means for estimating a mobility state of a user equipment located in a coverage area of a first base station and a second base station,
if it is determined that the user equipment is in a high mobility state,
means for configuring only a primary serving cell at the first base station.

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

### BRIEF DESCRIPTION OF THE DRAWINGS

These and other objects, features, details and advantages will become more fully apparent from the following detailed description of aspects/embodiments of the present invention which is to be taken in conjunction with the appended drawings, in which:

FIG. 1 is a diagram illustrating a communication network configuration where examples of aspects of the present invention are implemented.

FIG. 2 is a flowchart illustrating a method according to certain aspects of the present invention.

FIG. 3 is a block diagram showing an example of an apparatus according to certain aspects of the present invention.

FIG. 4 is a flowchart illustrating another method according to certain aspects of the present invention.

FIG. 5 is a block diagram showing another example of an apparatus according to certain aspects of the present invention.

### DETAILED DESCRIPTION

In the following, examples and embodiments of the present invention are described with reference to the drawings. For illustrating the present invention, the examples and embodiments will be described in connection with a cellular communication network based on a 3GPP based communication system, for example an LTE/LTE-A based system. However, it is to be noted that the present invention is not limited to an application using such types of communication system, but is also applicable in other types of communication systems and the like.

Basic system architecture of a communication network where examples of embodiments of the invention are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station or eNB, which control a coverage area also referred to as a cell and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element or terminal device like a UE and a communication network control element like a base transceiver station or eNB, besides those described in detail herein below.

Furthermore, the described network elements, such as terminal devices like UEs, communication network control elements of a macro cell, like an MeNB, communication network control elements of a small (pico, micro, femto etc.) cell, like an PeNB and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

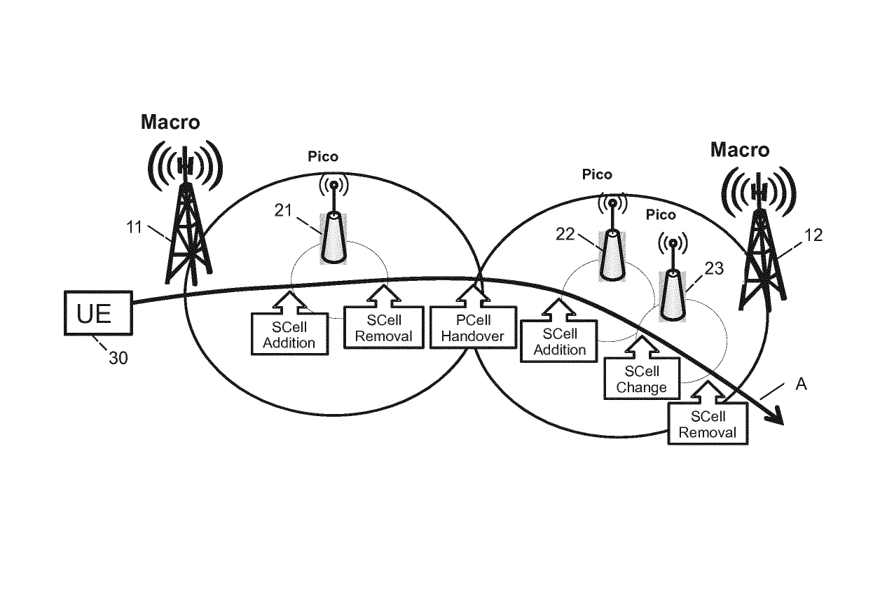

With regard to FIG. 1, a diagram illustrating a general configuration of a communication network is shown where examples of embodiments of the invention are implemented. It is to be noted that the configuration shown in FIG. 1 shows only those devices, network elements and parts which are useful for understanding principles underlying the examples of embodiments of the invention. As also known by those skilled in the art there may be several other network elements or devices involved in a communication between the communication device (UE) and the network which are omitted here for the sake of simplicity.

In FIG. 1, a communication network configuration is illustrated in which examples of embodiments of the invention are implementable. The network according to FIG. 1 is for example based on 3GPP specifications and forms a heterogeneous network including primary serving cells (Pcells), indicated by solid lines, and several secondary cells (Scells), indicated by broken lines. It is to be noted that the general functions of the elements described in connection with FIG. 1 as well as of reference points/interfaces therebetween are known to those skilled in the art so that a detailed description thereof is omitted here for the sake of simplicity.

As shown in FIG. 1, in the exemplary communication network, Pcells are formed by macro cell controller by a communication network control element such as eNBs (Macro cell eNBs or MeNBs) 11 and 12. The eNBs 11 and 12 provide, for example, a connection to the core network of the communication network. In the example shown in FIG. 1, it is assumed that the Pcell uses a carrier on a frequency f1.

In the macro cell, one or more small cells or secondary cells (Scells) are located. Each small cell is controlled by an own communication network control element, such as eNBs 21, 22 and 23 (referred to as pico eNBs or PeNBs). In the example shown in FIG. 1, it is assumed that the Scells use a carrier on a frequency f2 being different to f1, as discussed above (i.e. a high frequency compared to frequency f1). The PeNBs 21, 22 and 23 and the MeNB 11 and 12 are connected with each other, for example by a backhaul network, like, for example, an S1 or X2 interface (not shown in FIG. 1).

Furthermore, a communication element or terminal device UE 30 is assumed to be located in the communication network. The UE 30 is configured to communicate with the communication network via at least one eNB by using for example an air interface. It is assumed that for the communication of the UE 30, CA is used, in particular inter-site carrier aggregation using carriers f1 and f2.

When the UE 30 moves in the coverage areas of the respective cells, for example as indicated by arrow A in FIG. 1, the UE is within the coverage area controlled by the MeNBs 11 and 12, respectively, while entering and leaving the coverage areas controlled by the PeNBs 21, 22 and 23 (points of entering and leaving the small cells are indicated by bold arrows at the respective coverage edges).

Given the scenario as illustrated in FIG. 1, the problem addressed in the present invention is as follows.

It is desirable to only have users with low to medium UE speed connected to the small cells, i.e. only such users shall be allowed to have SCell configured on the small cell layer.

Thus, UEs moving at higher velocities shall only be served by the macro-layer, i.e. these should be restricted to only have PCell configured at the macro, while never having SCell on the small cell.

It is desirable to achieve these two objectives in order to avoid having very short connection times to an SCell. Short connection times are undesirable, as the users could anyway only be able to receive fairly modest amount of data, and the signaling overhead from cell addition/removal would therefore not be worth the effort.

According to a first aspect of the present invention, it is proposed that the UE shall use autonomous Mobility State Estimation (MSE) to roughly estimate its mobility speed, enumerated at [low, medium, high] as defined in 3GPP TS 36.331 or TS 36.304.

Other procedures for estimating mobility, including direct or indirect speed measurement, may also be applied. By high mobility state, it is referred to the state as defined by MSE, or a similar definition like the speed being above a certain threshold.

If it is determined that a UE is in the high mobility state (i.e. if the user is estimated to move at high speed above a certain threshold), SCell should not be configured for this UE. This means that such UEs shall not report any RRM mobility events back to the network related to SCell addition.

For the considered scenario, this means that UEs in high mobility state shall not report RRM measurement events for carrier f2. Only UEs in low or medium mobility state shall report RRM measurement events.

Thus, according to the first aspect of the present invention, the network configures the UEs to only report SCell related RRM measurements for a certain carrier (i.e. carrier f2 for the above described scenario) if the UE is in low or medium mobility state, i.e. if the UE is not moving fast, i.e. moves with a speed below a certain threshold.

A second aspect of the present invention relates to cases where an UE autonomous SCell mobility is used.

In such a case, an UE receives and processes a list of candidate communication cells usable as target cells for an autonomous mobility procedure conducted by the UE. The list is sent, for example, from the MeNB 11 or 12 and at least one of an information element indicating a physical cell identification of each candidate communication cell (PCI), a carrier identification element indicating a component carrier to which the autonomous mobility procedure is to be directed, and/or a timer information indicating a time period in which the candidate communication cell is allowed to participate in the autonomous mobility procedure. For example, the list is received in the form of measurement configuration information.

Further, the UE detects communication cells suitable for establishing a communication connection. The detection is done, for example, in commonly known ways.

On the basis of the received list, the UE determines whether the detected communication cell is comprised in the list of candidate communication cells for the autonomous mobility procedure.

If the UE does not identify the detected cell in the list, a default processing according to current standards is conducted for further mobility procedure (e.g. measurement reports etc.).

Otherwise, in case it is determined that the detected cell is a candidate cell, an allowance to conduct the autonomous mobility procedure to request immediate access to the detected cell as a target cell is provided.

Then, the UE conducts a decision procedure for deciding whether the autonomous mobility procedure is to be conducted to the target cell (i.e. the cell detected in the previous step). The decision is based, for example, on a connection quality evaluation related to an existing connection to another cell (even to another candidate cell) and a connection to be established to the target cell. If the UE decides to establish a connection to the detected cell, according to examples of embodiments of the invention, it requests in the autonomous mobility procedure a connection establishment via a random access channel to get immediate access to the target cell.

Thus, in the above described case of UE autonomous SCell mobility, the UE does not send RRM mobility events to the network for SCell mobility purposes. For such cases, the UE autonomously requests SCell configuration (addition) by sending a message to the small cell on the RACH.

Thus, for cases with UE autonomous SCell mobility, according to the second aspect of the present invention, it is proposed that UEs in high mobility state shall not send any requests (on RACH) for having small cells as SCell. Sending UE autonomous requests for SCell addition shall therefore only be allowed for UEs in low and medium mobility state and shall be prohibited for UEs in high mobility state, i.e. for UEs that are moving with a speed above a certain threshold.

Thus, according to the second aspect of the present invention, only UEs in low and medium mobility state are allowed to make UE autonomous SCell addition requests.

According to a third aspect of the present invention, for other cases where UE is not applying the MSE procedure, the network can use information about the UE mobility, e.g. the S1 information element IE History Information containing the last 16 cells and the cell types the UE has visited in RRC connected state, as specified in TS 36.413.

Here, the network can estimate the UE mobility characteristics based on the time spent in previous cells and the related cell types. When network notices that UE is a fast moving UE in terms of rate of cell changes, the network can decide not to configure UE with SCell, even if there is a measurement report available indicating that SCell would be available.

The IE History Information can be extended with the knowledge of previously added SCells and network can use this new information for identifying the usefulness of configuring SCell for UE, thus the signaling overhead from SCell addition/removal would be minimized (i.e. by allowing small cells as SCells if it is recognized a dense small cells deployment, such that users can receive a significant amount of data with a modest signaling overhead).

The solution according to the third aspect of the present invention benefits from extension of the S1 IE History Information to also include knowledge of previous cells that a UE have had as SCell. The solution according to the third aspect of the present invention can be extended to include X2 interface between eNBs.

The advantage of the proposed solution according to the first to third aspect of the present invention is that SCell configuration on small cell layer is avoided for higher speed users, i.e. users which are desirable in only being served on the macro layer.

It is noted that the three proposed solutions according to the first to third aspect as described above are not mutual exclusive, but could also be considered as complementary solutions.

In the following, a specific example of the present invention will be described with reference to the drawings.

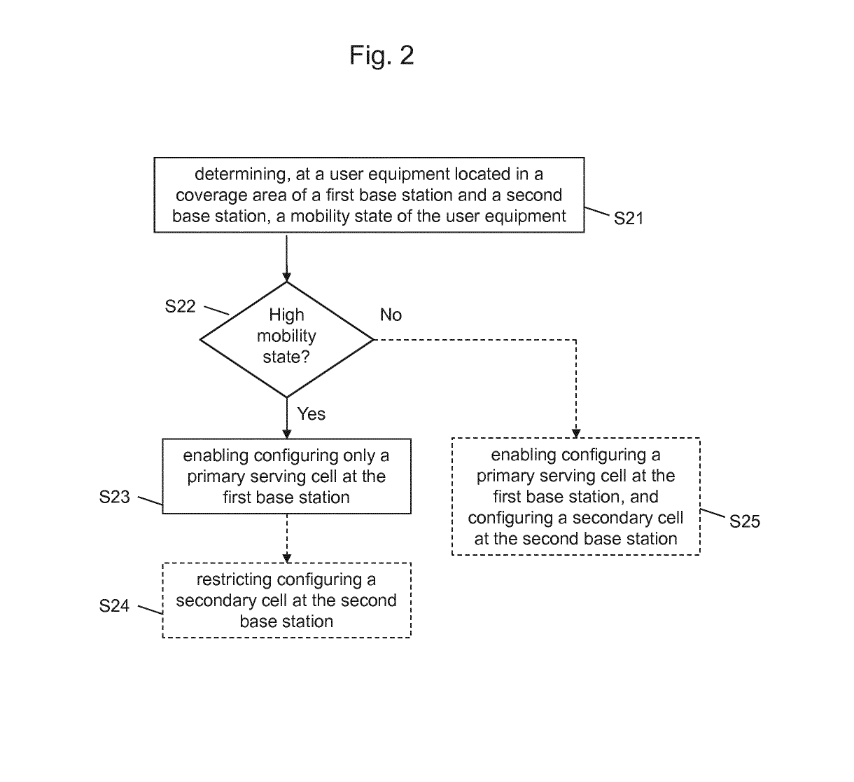

FIG. 2 is a flowchart illustrating a method according to certain aspects of the present invention.

According to certain aspects of the present invention, the method comprises determining, in a step S21, at a user equipment located in a coverage area of a first base station and a second base station, a mobility state of the user equipment. If it is determined in a step S22 that the user equipment is in the high mobility state, the method further comprises enabling configuring only a primary serving cell at the first base station in a step S23.

According to certain aspects of the present invention, the method further comprises restricting configuring a secondary cell at the second base station in a step S24.

According to certain aspects of the present invention, restricting configuring a secondary cell at the second base station includes restricting transmission of radio resource management mobility events related to addition of a secondary cell to the network or includes restricting transmission of a request for addition of a secondary cell on a random access channel.

According to certain aspects of the present invention, the mobility state of the user equipment refers to a moving speed of the user equipment and the user equipment is in a high mobility state when the moving speed of the user equipment is higher than a predetermined threshold.

According to certain aspects of the present invention, if it is determined in step S22 that the user equipment is not in the high mobility state, the method optionally further comprises enabling configuring a primary serving cell at the first base station, and configuring a secondary cell at the second base station in a step S25.

According to certain aspects of the present invention, the first base station is a macro base station and the second base station is a small cell base station.

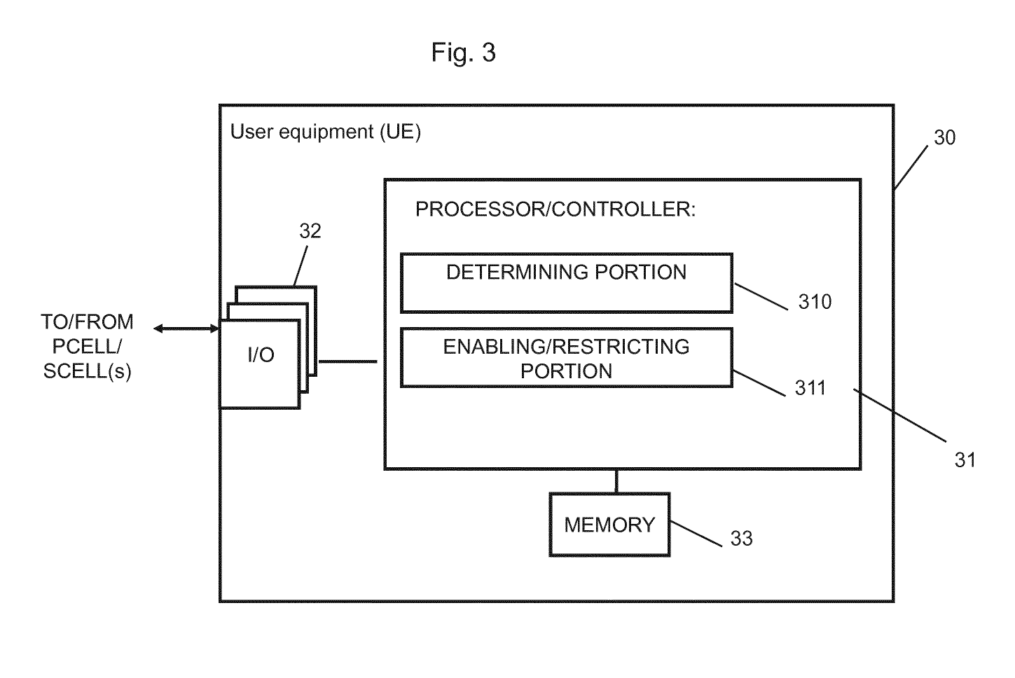

FIG. 3 is a block diagram showing an example of an apparatus according to certain aspects of the present invention.

In FIG. 3, a block circuit diagram illustrating a configuration of an apparatus, such as of UE 30, is shown, which is configured to implement the above described aspects of the invention. It is to be noted that the communication element or UE 30 shown in FIG. 3 may comprise several further elements or functions besides those described herein below, which are omitted herein for the sake of simplicity as they are not essential for understanding the invention. Furthermore, even though reference is made to a UE (or terminal device), the communication element may be also another device having a similar function, such as a chipset, a chip, a module etc., which can also be part of a UE or attached as a separate element to a UE, or the like.

The UE 30 may comprise a processing function or processor 31, such as a CPU or the like, which executes instructions given by programs or the like related to the flow control mechanism. The processor 31 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 32 denotes transceiver or input/output (I/O) units (interfaces) connected to the processor 31. The I/O units 32 may be used for communicating with one or more communication network control elements like the MeNB 11 and 12 or PeNBs 21, 22 and 23. The I/O units 32 may be a combined unit comprising communication equipment towards several network elements, or may comprise a distributed structure with a plurality of different interfaces for different network elements. Reference sign 33 denotes a memory usable, for example, for storing data and programs to be executed by the processor 31 and/or as a working storage of the processor 31.

The processor 31 is configured to execute processing related to the above described aspects. In particular, the processor 31 comprises a sub-portion 310 as a processing portion which is usable for determining a mobility state of the user equipment. The portion 310 may be configured to perform processing according to step S21 of FIG. 2, for example. Furthermore, the processor 31 comprises a sub-portion 311 usable as a portion for enabling configuring only a primary serving cell at the first base station, and optionally, restricting configuring a secondary cell at the second base station. The portion 311 may be configured to perform processing according to steps S23 and S24 of FIG. 2, for example. Furthermore, the sub-portion 311 is usable as a portion for enabling configuring a primary serving cell at the first base station, and configuring a secondary cell at the second base station. Thus, the portion 311 may be configured to perform processing according to step S25 of FIG. 2, for example.

For further functions of the user equipment according to further exemplary aspects of the present invention, reference is made to the above description of a method according to certain aspects of the present invention, as described in connection with FIG. 2.

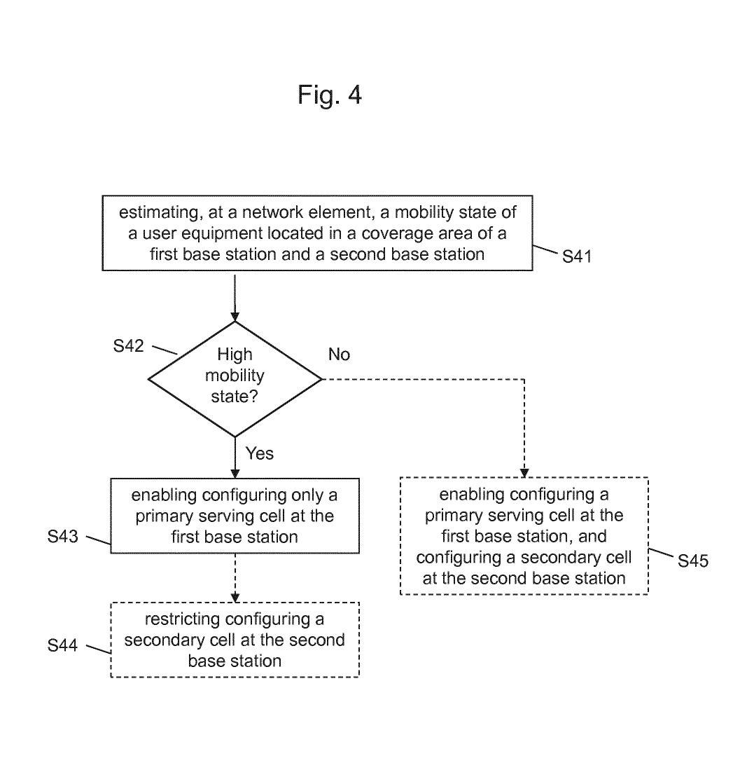

FIG. 4 is a flowchart illustrating a method according to certain aspects of the present invention.

According to certain aspects of the present invention, the method comprises estimating, in a step S41, at a network element, a mobility state of a user equipment located in a coverage area of a first base station and a second base station. If it is determined in a step S42 that the user equipment is in the high mobility state, the method further comprises enabling configuring only a primary serving cell at the first base station in a step S43.

According to further aspects of the present invention, the method further comprises restricting configuring a secondary cell at the second base station in a step S44.

According to further aspects of the present invention, the mobility state of the user equipment is estimated based on a rate of cell changes obtained based on a time the user equipment has been located in previous cells and the type of the cells.

The user equipment is in a high mobility state if the rate of cell changes is higher than a threshold.

According to further aspects of the present invention, if it is determined in step S42 that the user equipment is not in the high mobility state, the method optionally further comprises enabling configuring a primary serving cell at the first base station, and configuring a secondary cell at the second base station in a step S45.

According to further aspects of the present invention, the first base station is a macro base station and the second base station is a small cell base station.

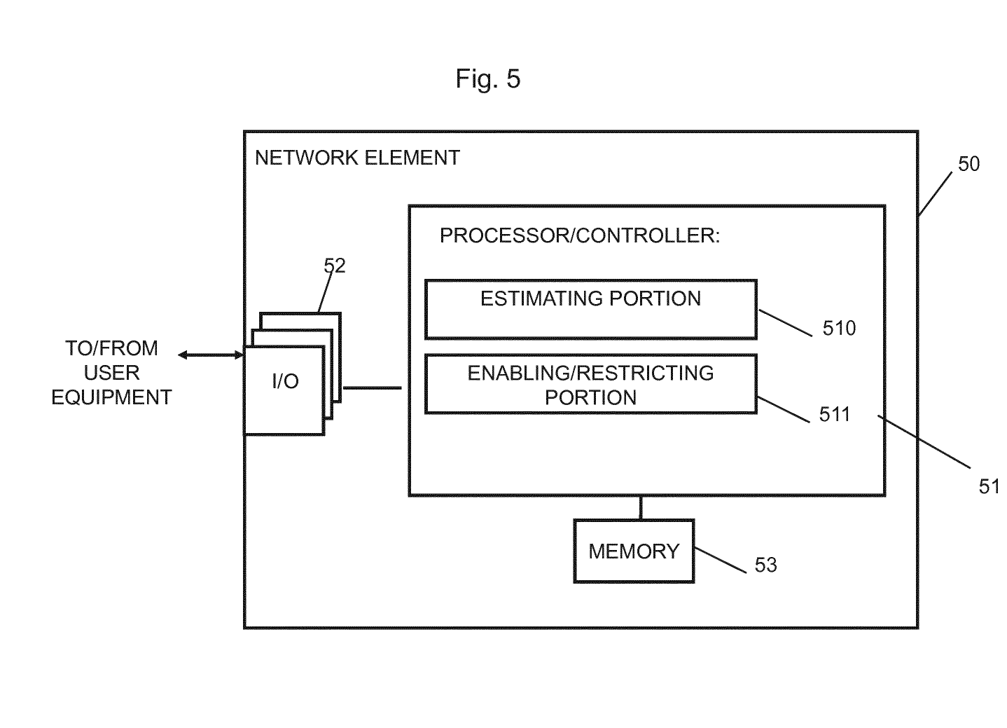

FIG. 5 is a block diagram showing an example of an apparatus according to certain aspects of the present invention.

In FIG. 5, a block circuit diagram illustrating a configuration of an apparatus, such as of a network element 50, is shown, which is configured to implement the above described aspects of the invention. It is to be noted that the network element 50 shown in FIG. 5 may comprise several further elements or functions besides those described herein below, which are omitted herein for the sake of simplicity as they are not essential for understanding the invention. Furthermore, even though reference is made to a network element, the communication element may be also another device having a similar function, such as a chipset, a chip, a module etc., which can also be part of the network element or attached as a separate element to the network element, or the like.

The network element 50 may comprise a processing function or processor 51, such as a CPU or the like, which executes instructions given by programs or the like related to the flow control mechanism. The processor 51 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 52 denotes transceiver or input/output (I/O) units (interfaces) connected to the processor 51. The I/O units 52 may be used for communicating with one or more user equipments, or the like. The I/O units 52 may be a combined unit comprising communication equipment towards several network elements, or may comprise a distributed structure with a plurality of different interfaces for different network elements. Reference sign 53 denotes a memory usable, for example, for storing data and programs to be executed by the processor 51 and/or as a working storage of the processor 51.

The processor 51 is configured to execute processing related to the above described aspects. In particular, the processor 51 comprises a sub-portion 510 as a processing portion which is usable for estimating a mobility state of the user equipment. The portion 510 may be configured to perform processing according to step S41 of FIG. 4, for example. Furthermore, the processor 51 comprises a sub-portion 511 usable as a portion for enabling configuring only a primary serving cell at the first base station, and optionally, restricting configuring a secondary cell at the second base station. The portion 511 may be configured to perform processing according to steps S43 and S44 of FIG. 4, for example. Furthermore, the sub-portion 511 is usable as a portion for enabling configuring a primary serving cell at the first base station, and configuring a secondary cell at the second base station. Thus, the portion 511 may be configured to perform processing according to step S45 of FIG. 4, for example.

For further functions of the network element according to further exemplary aspects of the present invention, reference is made to the above description of a method according to certain aspects of the present invention, as described in connection with FIG. 4.

In the foregoing exemplary description of the apparatus and the network element, only the units/means that are relevant for understanding the principles of the invention have been described using functional blocks. The apparatus may comprise further units/means that are necessary for its respective operation. However, a description of these units/means is omitted in this specification. The arrangement of the functional blocks of the apparatus is not construed to limit the invention, and the functions may be performed by one block or further split into sub-blocks.

When in the foregoing description it is stated that the apparatus (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

For the purpose of the present invention as described herein above, it should be noted that

method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;

generally, any method step is suitable to be implemented as software or by hardware without changing the idea of the aspects/embodiments and its modification in terms of the functionality implemented;

method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;

devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;

an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the aspects/embodiments and general and specific examples described above are provided for illustrative purposes only and are in no way intended that the present invention is restricted thereto. Rather, it is the intention that all variations and modifications which fall within the scope of the appended claims are covered.

### ABBREVIATIONS

CA Carrier Aggregation
CC Component Carrier
eNB E-UTRAN NodeB
IE Information Element
MSE Mobility State Estimation
PCell Primary Cell
PRB Physical Resource Block
RACH Random Access Channel
RRM Radio Resource Management
RSRP Reference Signal Received Power
RSRQ Reference Signal Received Quality
SCell Secondary Cell
UE User Equipment

1. A method, comprising:
determining, at a user equipment located in a coverage area of a first base station and a second base station, a mobility state of the user equipment,
if it is determined that the user equipment is in a high mobility state,
enabling configuring only a primary serving cell at the first base station.

2. The method according to claim 1, further comprising
restricting configuring a secondary cell at the second base station.

3. The method according to claim 2, wherein
restricting configuring a secondary cell at the second base station includes restricting transmission of radio resource management mobility events related to addition of a secondary cell to the network.

4. The method according to claim 2, wherein
restricting configuring a secondary cell at the second base station includes restricting transmission of a request for addition of a secondary cell on a random access channel.

5. The method according to claim 1, wherein
the mobility state of the user equipment refers to a moving speed of the user
equipment and the user equipment is in a high mobility state when the moving speed of the user equipment is higher than a predetermined threshold.

6. The method according to claim 1, further comprising
if it is determined that the user equipment is not in a high mobility state,
enabling configuring a primary serving cell at the first base station and configuring a secondary cell at the second base station.

7. The method according to claim 1 wherein
the first base station is a macro base station and the second base station is a small cell base station.

8. A method, comprising:
estimating, at a network element, a mobility state of a user equipment located in a coverage area of a first base station and a second base station,
if it is determined that the user equipment is in a high mobility state,
configuring only a primary serving cell at the first base station.

9. The method according to claim 8, further comprising
restricting configuring a secondary cell at the second base station.

10. The method according to claim 8, wherein
the mobility state of the user equipment is estimated based on a rate of cell changes obtained based on a time the user equipment has been located in previous cells and the type of the cells.

11. The method according to claim 10, wherein
the user equipment is in a high mobility state if the rate of cell changes is higher than a threshold.

12. The method according to claim 8, further comprising
if it is determined that the user equipment is not in a high mobility state,
enabling configuring a primary serving cell at the first base station and configuring a secondary cell at the second base station.

13. The method according to claim 8, wherein
the first base station is a macro base station and the second base station is a small cell base station.

14. An apparatus for use in a user equipment, comprising:
at least one processor,
at least one interface to at least one other network element, and
at least one memory for storing instructions to be executed by the processor, wherein
the at least one memory and the instructions are configured to, with the at least one processor, cause the apparatus at least to perform:
determining, at the user equipment located in a coverage area of a first base station and a second base station, a mobility state of the user equipment,
if it is determined that the user equipment is in a high mobility state, enabling configuring only a primary serving cell at the first base station.

15. The apparatus according to claim 14, wherein the at least one memory and the instructions are further configured to, with the at least one processor, cause the apparatus to perform
restricting configuring a secondary cell at the second base station.

16. The apparatus according to claim 15, wherein
restricting configuring a secondary cell at the second base station includes restricting transmission of radio resource management mobility events related to addition of a secondary cell to the network.

17. The apparatus according to claim 15, wherein
restricting configuring a secondary cell at the second base station includes restricting transmission of a request for addition of a secondary cell on a random access channel.

18. The apparatus according to claim 14, wherein
the mobility state of the user equipment refers to a moving speed of the user equipment and the user equipment is in a high mobility state when the moving speed of the user equipment is higher than a predetermined threshold.

19. The apparatus according to claim 14, wherein the at least one memory and the instructions are further configured to, with the at least one processor, cause the apparatus to perform, if it is determined that the user equipment is not in a high mobility state,
enabling configuring a primary serving cell at the first base station and configuring a secondary cell at the second base station.

20. The apparatus according to claim 14, wherein
the first base station is a macro base station and the second base station is a small cell base station.

21. An apparatus, comprising:
at least one processor,
at least one interface to at least one other network element, and
at least one memory for storing instructions to be executed by the processor, wherein the at least one memory and the instructions are configured to, with the at least one processor, cause the apparatus at least to perform:
estimating a mobility state of a user equipment located in a coverage area of a first base station and a second base station,
if it is determined that the user equipment is in a high mobility state, configuring only a primary serving cell at the first base station.

22. The apparatus according to claim 21, wherein the at least one memory and the instructions are further configured to, with the at least one processor, cause the apparatus to perform
restricting configuring a secondary cell at the second base station.

23. The apparatus according to claim 21, wherein
the mobility state of the user equipment is estimated based on a rate of cell changes obtained based on a time the user equipment has been located in previous cells and the type of the cells.

24. The apparatus according to claim 23, wherein
the user equipment is in a high mobility state if the rate of cell changes is higher than a threshold.

25. The apparatus according to claim 21, wherein the at least one memory and the instructions are further configured to, with the at least one processor, cause the apparatus to perform, if it is determined that the user equipment is not in a high mobility state,
enabling configuring a primary serving cell at the first base station and configuring a secondary cell at the second base station.

26. The apparatus according to claim 21, wherein
the first base station is a macro base station and the second base station is a small cell base station.

27. (canceled)

28. (canceled)

29. A computer program product including a program for a processing device, comprising software code portions for performing the steps of claim 1 when the program is run on the processing device.

30. The computer program product according to claim 29, wherein the computer program product comprises a computer-readable medium on which the software code portions are stored.

31. The computer program product according to claim 29, wherein the program is directly loadable into an internal memory of the processing device.
